(19) United States
(12) Patent Application Publication
(10) Pub. No.: US 2020/0380889 A1
(43) Pub. Date: Dec. 3, 2020

(54) SYSTEMS AND METHODS FOR USING CHALLENGES TO ACHIEVE GOALS

(71) Applicant: Wells Fargo Bank, N.A., San Francisco, CA (US)

(72) Inventors: Julie T. Fitzpatrick, Houston, TX (US); Minhthe Luu, Mount Laurel, NJ (US); Andrew L. Martinez, San Francisco, CA (US); Uma Meyyappan, Freemont, CA (US); David Patron, San Francisco, CA (US); Matthew S. Rogers, Hoboken, NJ (US); Dana Roytenberg, San Francisco, CA (US); Penny Thompson, Ankeny, IA (US); Paul Vittimberga, Oakland, CA (US); Raissa Williams, San Francisco, CA (US); Cindy Wong-Zarahn, Burlingame, CA (US)

(21) Appl. No.: 15/706,058

(22) Filed: Sep. 15, 2017

Related U.S. Application Data
(60) Provisional application No. 62/491,197, filed on Apr. 27, 2017.

(51) Int. Cl. G09B 19/18; G06Q 40/02; G09B 5/12

(52) U.S. Cl. CPC G09B 19/18; G09B 5/125; G09B 5/12; G06Q 40/02

(57) ABSTRACT

Systems and methods are structured to impart an emotional connection to a goal and to generate customized, appropriate challenges that maintain participant engagement by handicapping certain parameters. In one embodiment, a financial health computing system is configured to: generate a first profile for a first participant; generate a first goal for the first participant, the first goal comprising a first plurality of milestones and a first plurality of rewards; assess a participant's progress based on a first status item; and generate an advisory alert for the first participant based on the first status item. The advisory alert comprises a recommended financial health activity and is configured to accept a user input for directing an auxiliary system to perform the recommended financial health activity. The first goal and the first plurality of rewards are customized to the first participant based at least in part on the first profile.

### PRIORITY CLAIM

The present application claims priority to U.S. patent application Ser. No. 62/491,197, filed on Apr. 27, 2017, the contents of which are incorporated herein by reference in their entirety.

### TECHNICAL FIELD

The present application relates generally to systems and methods for achieving goals.

### BACKGROUND

Individuals often rely on computer-based systems to manage their personal finances. Certain personal financial systems allow users to create budgets and goals and to classify transactions into various categories. However, there is little or no emotional connection to financial success with such personal financial systems. For example, while people may desire wealth, financial management is not viewed in the same way as, for example, fitness where challenges of various difficulty levels may be defined to keep participants interested. Therefore, systems and methods are desirable that impart an emotional connection to a financial health goal and generate challenges of appropriate difficulty to maintain participant engagement.

### SUMMARY

One embodiment relates to a computer-implemented method for monitoring progress towards financial goals using a financial health computing system that has an assessment circuit, a progress tracking circuit, an integrated financial health monitoring circuit, and a financial health advisory engine. The method includes: generating, by the assessment circuit, a first profile for a first participant; generating, by the progress tracking circuit, a first goal for the first participant, the first goal comprising a first plurality of milestones and a first plurality of rewards, wherein the first goal and the first plurality of rewards are customized to the first participant based at least in part on the first profile; assessing, by the progress tracking circuit, a participant's progress; and generating, by a financial health advisory engine, an advisory alert for the first participant based on the first status item as a progress input is obtained, the advisory alert comprising a recommended financial health activity and an interface for accepting a user input for directing an auxiliary system to perform the recommended financial health activity.

Another embodiment relates to a financial health computing system including an assessment circuit, a progress tracking circuit, an integrated financial health monitoring circuit, a financial health advisory engine, and at least one processor and memory. The memory has instructions stored therein that are executed by the at least one processor and cause the at least one processor to: generate, by the assessment circuit, a first profile for a first participant; generate, by the progress tracking circuit, a first goal for the first participant, the first goal comprising a first plurality of milestones and a first plurality of rewards, wherein the first goal and the first plurality of rewards are customized to the first participant based at least in part on the first profile; assess, by the progress tracking circuit, a participant's progress; and generate, by a financial health advisory engine, an advisory alert for the first participant based on the first status item, the advisory alert comprising a recommended financial health activity and an interface for accepting a user input for directing an auxiliary system to perform the recommended financial health activity.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1A is a diagram of a financial health computing system, according to an example embodiment;

FIG. 1B is a diagram of the mobile device of FIG. 1A, according to an example embodiment;

FIG. 2 is a flowchart of a computer-implemented method for monitoring progress towards goals using the financial health computing system of FIG. 1A, according to an example embodiment;

FIG. 3 is a flowchart of a computer-implemented method for handicapping a challenge using the financial health computing system of FIG. 1A, according to an example embodiment;

FIG. 4 is a flowchart of a computer-implemented method for generating a profile using the financial health computing system of FIG. 1A, according to an example embodiment;

FIG. 5A is a flowchart of a computer-implemented method for generating advisory alerts using the financial health computing system of FIG. 1A, according to an example embodiment;

FIG. 5B is a schematic diagram of an interface for managing activity instructions for auxiliary systems based on an advisory alert generated by the financial health computing system of FIG. 1A and presented to a participant on a mobile device, according to an example embodiment;

FIG. 6A is a flowchart of a computer-implemented method for managing challenge discovery via a social network associated with the user of the financial health computing system of FIG. 1A, according to an example embodiment;

FIG. 6B is a diagram of an interface presented to a participant on a mobile device for a challenge discovery in the financial health computing system of FIG. 1A, according to an example embodiment;

FIG. 7 is a flowchart of a computer-implemented method for generating a bank-agnostic record that associates the financial health computing system of FIG. 1A with one or more auxiliary system(s), according to an example embodiment; and

FIG. 8 is a flowchart of a computer-implemented method for anonymizing the bank-agnostic record, according to an example embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

### DETAILED DESCRIPTION

Referring to the figures generally, various embodiments described herein relate to systems and methods for monitoring progress towards a goal, such as a financial health goal, using a financial health computing system. A financial health goal may be associated with a challenge. The term “challenge” refers to a competition between two or more participants with respect to achieving a goal. As part of the challenge, the financial health computing system may also track a participant's progress towards the goal and monitor various key performance indicators to optimize the participant's performance so as to help reach that goal. Beneficially and according to the present disclosure, the financial health computing system is structured to impart an emotional connection between the participant and the financial health goal in order to maintain and encourage participant engagement.

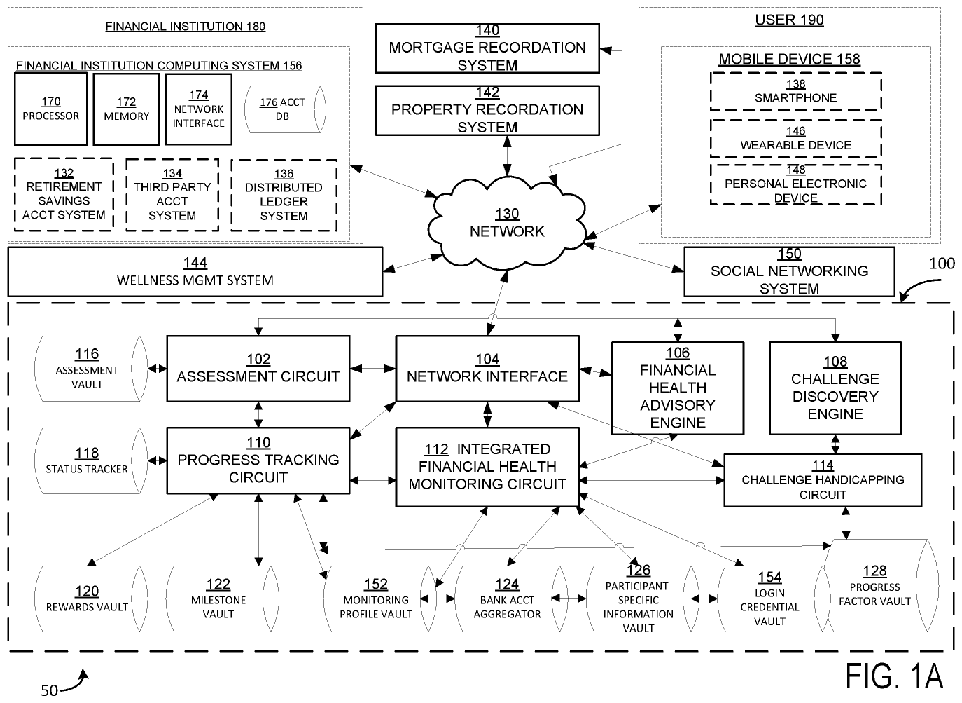

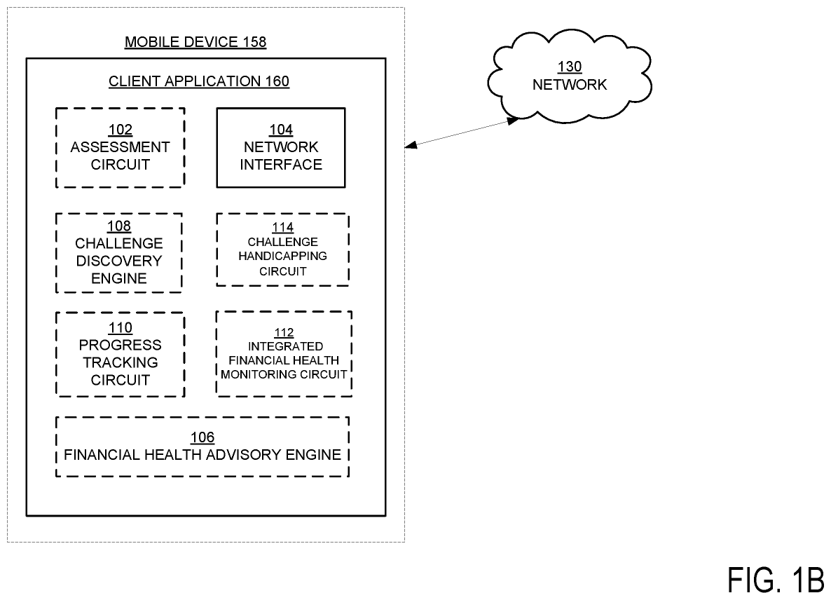

Referring now to FIG. 1A, a diagram of a computing system 50 is shown, according to an example embodiment. The computing system 50 is shown to include a financial health computing system 100, a financial institution computing system 156 associated with a financial institution 180, a mobile device 158 associated with a user 190, a mortgage recordation system 140, a property recordation system 142, a wellness management system 144, and a social networking system 150. All of these components are communicatively coupled to each other over the network 130. The network 130 may be any type of network. For example, the network 130 may include a wireless network interface (e.g., 802.11X, ZigBee, Bluetooth, Internet, etc.), a wired network interface (e.g., Ethernet), or any combination thereof. In some embodiments, the network 130 is a proprietary banking network that provides a relatively secure communications network for the components of FIG. 1A. The network 130 is structured to permit the exchange of data, values, instructions, messages, and the like between and among the financial health computing system 100, financial institution computing system 156, mobile device 158, mortgage recordation system 140, property recordation system 142, wellness management system 144, and social networking system 150. Any suitable communications protocol may be used (e.g., Internet Protocol Suite, near-field communications).

As shown, the financial institution 180 (for example, a banking entity) includes or is associated with a financial institution computing system 156, which includes a retirement savings account system 132, a third party account system 134, and a distributed ledger system 136. The financial institution computing system 156 includes a processor 170 and a memory device 172. The processor 170 may be implemented as a general-purpose processor, an application specific integrated circuit (ASIC), one or more field programmable gate arrays (FPGAs), a digital signal processor (DSP), a group of processing components, or other suitable electronic processing components. The one or more memory devices 172 (e.g., RAM, ROM, NVRAM, Flash Memory, hard disk storage, etc.) may store data and/or computer code for facilitating at least some of the various processes described herein. In this regard, the memory 172 may store programming logic that, when executed by the processor 170, controls at least some of the operations of the financial institution computing system 156.

As shown, the financial institution computing system 156 includes a network interface 174. The network interface 174 facilitates the sending and receiving of data over the network 130 (e.g., to and from the mobile device 158, etc.). The financial institution computing system 156 may also include an account database 176 that stores customer information and account information relating to accounts held with the financial institution 180. In this regard and as mentioned above, more than one financial institution 180 with an associated financial institution computing system 156 may be communicably coupled to the components of FIG. 1A over the network 130 to account for accounts held by the user with two or more financial institutions.

As shown, the user 190 may have or be associated with a mobile device 158. The user 190 may be an individual, business representative, large and small business owner, and any other similar entity. In some configurations, the user 190 may have a financial account (e.g., checking, savings, investment, loan such as a mortgage, etc.) at one or more of the financial institutions 180. The mobile device 158 may include any wearable device 146. Wearable devices refer to any type of device that a user wears including, but not limited to, a watch (e.g., a smart watch), glasses (e.g., eye glasses, sun glasses, smart glasses, etc.), bracelet (e.g., a smart bracelet), etc. Mobile devices 158 may also include any type of mobile device of a user 190 including, but not limited to, a phone (e.g., a smartphone 138, etc.) and a personal electronic device 148 (e.g., a tablet computer, a laptop computer, a personal digital assistant, etc.). Accordingly, the mobile device 158 may include a display device (e.g., a screen) and one or more input/output devices (e.g., a touch screen, microphone, speaker, keyboard, etc.). The mobile device may include a mobile financial health system client 160 as shown in FIG. 1B.

Referring further to the components of FIG. 1A as shown, the mortgage recordation system 140 is a computing system that manages information and records pertaining to home mortgages. The property recordation system 142 is a computing system that manages information and records pertaining to property ownership and title transfers. The social networking system 150 is a computing system that manages information pertaining to electronic records of a user's social connections. Each of these systems may include a network interface for communicating with other components of the computing system 50 via the network 130 as described herein.

Referring particularly to the financial health computing system 100, as shown, the financial health computing system 100 includes an assessment circuit 102, an interface circuit 104, a financial health advisory engine 106, a challenge discovery engine 108, a progress tracking circuit 110, an integrated financial health monitoring circuit 112, and a challenge handicapping circuit 114. It should be understood that the terms “engine” and “circuit” are used herein interchangeably with a particular definition being provided herein below. As shown, components 102-114 are communicatively coupled to one or more of the following: an assessment vault 116, a status tracker 118, a rewards vault 120, a milestone vault 122, a bank account aggregator 124, a participant-specific information vault 126, a progress factor vault 128, a monitoring profile vault 152, and a login credential vault 154.

The assessment circuit 102 manages electronic user interfaces, information and messages about a user's preferences and motivating factors. These items may be stored in the assessment vault 116. According to various embodiments, one or more electronic user interfaces associated with the financial health monitoring system 100 may be implemented as interactive display(s), touch-responsive surface(s), and/or motion-responsive surface(s).

The interface circuit 104 manages communication between various components of the financial health computing system 100 and external (auxiliary) systems via the network 130.

The financial health advisory engine 106 manages electronic user interfaces, information, and messages pertaining to a user's planned actions that may affect the user's financial health. For example, when a user contemplates a purchase or another financial transaction, the financial health advisory engine may issue an alert suggesting a more financially viable course of action, such as putting the amount of the contemplated purchase in a savings account.

The challenge discovery engine 108 manages electronic user interfaces, information, and messages pertaining to a user's social connections who may be interested in joining a challenge. For example, the challenge discovery engine may link the user to other similarly situated users of a social network so that these individuals may compete against one another.

The progress tracking circuit 110 manages electronic user interfaces, information, and messages about a user's progress, including transactions, running totals of activities (such as spending by category), and the like. Transactions and running totals of activities may be stored in the status tracker 118. The progress tracking circuit 110 also manages rewards (incentives earned by a user) and milestones (events that need to occur in order to reach goals, such as saving an X amount of dollars). These items may be stored in the rewards vault 120, milestone vault 122, and/or monitoring profile vault 152. The progress tracking circuit 110 may manage these items using information from the progress factor vault 128, the information including handicapping factors. Handicapping factors are values used to equalize performance and progress data for different participants.

The integrated financial health monitoring circuit 112 manages parameters, messages, and items needed to build and monitor progress. These items may include a schedule for polling auxiliary systems stored in the monitoring profile vault 152, account login information distributed across the bank account aggregator 124, participant-specific information vault 126, the login credential vault 154 as described below, and handicapping factors stored in the progress factor vault 128 and managed via the challenge handicapping circuit 114.

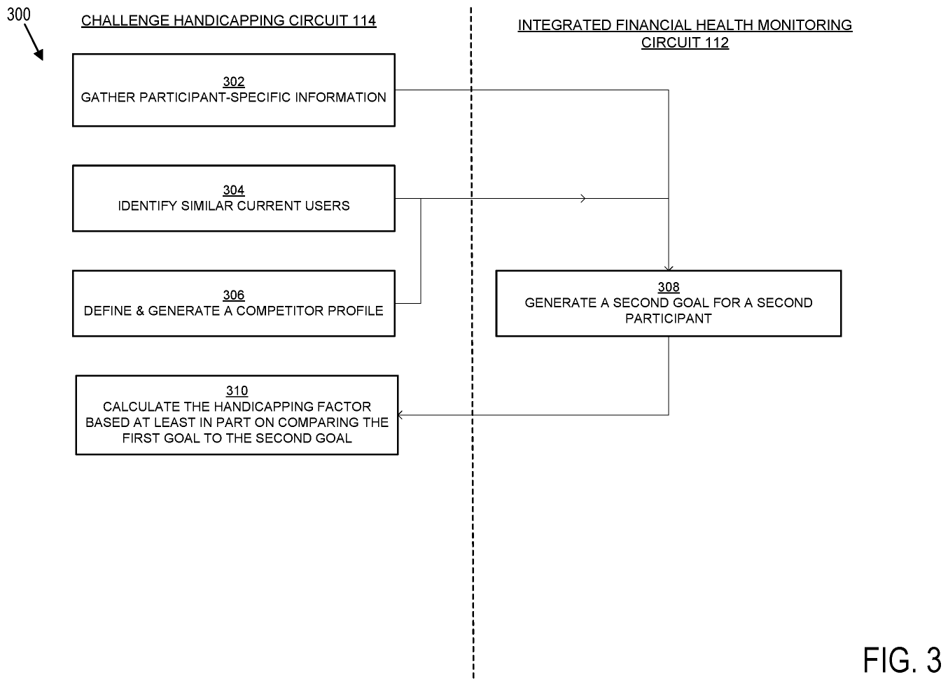

The challenge handicapping circuit 114 manages the parameters, messages, and items needed to equalize challenges among different participants, as explained, for example, with reference to FIG. 3.

Any of the assessment vault 116, status tracker 118, rewards vault 120, milestone vault 122, bank account aggregator 124, participant-specific information vault 126, progress factor vault 128, monitoring profile vault 152, and login credential vault 154 may be a database, a computer system, or a computer application suitable for and capable of the management, storage and processing of electronic information and communications. Such a system may be implemented, in various embodiments, as a relational database, a distributed ledger, a database for storing documents such as a PDF, MS Word, and so on. In some embodiments, electronic documents are parsed and data is thereby extracted by one or more of the circuits, enumerated herein, of the financial health computing system 100.

The financial health computing system 100 may communicate messages, instructions, values, commands, and electronic signals over the network 130 regarding the users' financial health and participation in challenges. In particular, the financial health computing system 100 is configured to relay and receive messages and electronic signals to and from various auxiliary systems and entities including, but not limited to the mortgage recordation system 140, the property recordation system 142, the wellness management system 144, the social networking system 150, the financial institution computing system 156, and/or the mobile device 158. In this regard, the financial health computing system 100 may connect to one or more components of FIG. 1A over the network 130 via the network interface 104. Thus, the network interface 104 may be a wireless interface transceiver including, but not limited to, an Internet card, a wireless network processor, a wireless docking device, or a radio frequency transceiver, and may facilitate the exchange of information, messages, communications, and the like over the network 130.

Referring now to FIG. 1B, the mobile device 158 is shown, according to an example embodiment. As shown, the mobile device 158 includes a mobile financial health system client 160. The mobile financial health system client 160 enables communication between the user of the mobile device and various components of the financial health computing system 100. For example, the mobile financial health system client 160 may further include any or all of the following: an assessment circuit 102, a financial health advisory engine 106, a challenge discovery engine 108, a progress tracking circuit 110, an integrated financial health monitoring circuit 112, a challenge handicapping circuit 114, and/or the status tracker 118. Thus, the depiction of these circuits with the financial health system is not meant to be limiting and one or more of these components may be included in the mobile device 158. Additionally, the mobile financial health system client 160 may include or may be communicatively coupled to one or more data storage entities of the financial health computing system 100. For example, in some embodiments, the status tracker 118 resides on the mobile device 158 and is managed by the mobile financial health system client 160 through the progress tracking circuit 110 such that information and electronic messages pertaining to a participant's progress towards financial health goals are collected and tracked on the mobile device 158.

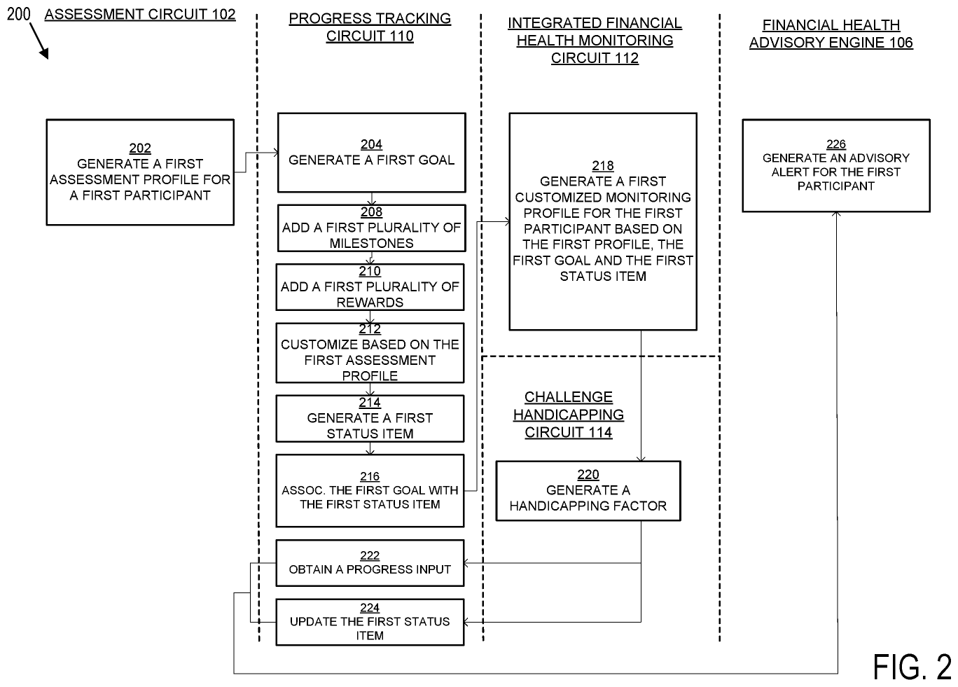

Referring now to FIG. 2, a flowchart of a computer-implemented method 200 for monitoring progress towards goals in a financial health computing system 100 is shown, according to an example embodiment. Because the method 200 may be performed by one or more components of FIGS. 1A-1B, reference may be made to these one or more components to aid explanation of method 200.

At process 202, a first profile for a first participant is generated by the assessment circuit 102. The first participant is a participant in a challenge, such as the user 190. In some embodiments, the first profile is stored in the assessment vault 116. As used herein, the term “profile” refers to an electronic record of the first participant's personal, health, financial planning, or asset management preferences and/or predispositions (e.g., likes, lifestyle goals, etc.). Information for the first profile is supplied by the first participant, for example, via the social networking system 150 and mobile device 158 though data entry or a data feed.

In some embodiments, information for the first profile is provided, in the form of recommendations, by the financial health advisory engine 106 of the financial health computing system 100. For example, the participant may have an account in the financial institution computing system 156, which is communicably coupled to the system 100. The financial health advisory engine 106 may receive account/financial information regarding the user. Based on this information, the financial health advisory engine 106 may generate a recommendation regarding the user's financial planning goals. The recommendation generated by the financial health advisory engine 106 includes recommended savings goals, spending recommendations, and the like.

In some embodiments, the first profile includes geotracking information regarding a history or pattern of geographic locations visited by the first participant. For example, geolocation information from the mobile device 158 may be used to compile a history of movement of the first participant for the past predefined X time period. From the history, the assessment circuit 102 may determine the frequency of visits, potential likes, and any other type of indicator regarding the travels of the participant.

The first profile further includes an electronic record of the first participant's preferences. For example, if a participant is risk-averse, the participant may not be presented with advisory alerts suggesting placement of funds in high-yield, high-risk investment account. If a participant has a family, the participant may be presented with advisory alerts asking the participant to invite his or her spouse to join a challenge. Advisory alerts may be customized to offer the participant an opportunity to purchase life or health insurance plans via the financial health advisory engine 106.

The preferences may be determined based on information provided by the first participant or based on a history of the first participant's relevant behaviors. The history of relevant behaviors includes the participant's social networking history received from the social networking system 150. In some embodiments, the history of relevant behaviors includes transaction activity received from the retirement savings account system 132, third party account system 134, distributed ledger system 136, and/or property recordation system 142. In some embodiments, the history of relevant behaviors includes health information received from the wellness management system 144 and/or wearable device 146.

At process 204, a first goal is generated for the first participant by the progress tracking circuit 110. In some embodiments, the first goal is stored in the status tracker 118. The term “goal” refers to an electronic data structure that shows, via various variables, a participant's financial health objectives and the path towards achieving the same. The goal may be associated with one or more rewards and milestones, as explained further herein.

In an example embodiment as shown in FIG. 2, the first goal is associated with a first milestone, which may be stored in the milestone vault 122. In this context, the term “milestone” refers to an electronic progress marker regarding reaching the goal (e.g., 30% complete, etc.). To maintain participant engagement, goals may be associated with multiple milestones. For example, where a participant's goal may be to minimize private mortgage insurance and interest payments in connection with a home loan, a first milestone may be defined as paying down the loan to a certain amount to achieve an 80% loan-to-value (LTV) ratio and a second milestone may be defined as paying off the loan. Other examples of milestones include a desired savings amount, a purchase amount of an item, and/or an asset value.

In some instances, the first goal may be associated with a first plurality of rewards stored in the rewards vault 120. The term “reward(s),” as used herein, refers to one or more item(s) of value earned by and issued to a participant in recognition of reaching a milestone. For example, when a participant reaches the first milestone of 80% loan-to-value (LTV) by Dec. 31, 2017 (set, for example, for tax purposes), a reward in the form of a mortgage interest rebate or a mortgage interest credit may be earned by the participant.

In further reference to milestones, a milestone may represent a value-exchange transaction completed by a specified date. The term “value-exchange transaction” refers to an instance of purchasing or selling assets, such as a transfer of real property or a stock sale/purchase by a challenge participant.

As to rewards, each item in the plurality of electronic rewards represents a real-life reward earned by the participant. A plurality of rewards may include positive rewards, such as an accumulation of points, a deposit of fiat funds or currency into a savings account, a deposit of digital funds or currency into a distributed ledger account, a free file download from an entertainment system, an encouragement message, or an invitation to post a status message through the first participant's account on a social networking system. The plurality of rewards may also include a set of negative rewards, such as a charge, a monetary transfer to, for example, a social services organization of the first participant's choice, or a warning message. The plurality of rewards may include none, one, or more reward(s). In some embodiments, the plurality of rewards may be null.

In further reference to rewards, rewards in the plurality of rewards may be customized based at least in part on the first profile associated with the participant. For example, if the participant expresses a preference for reading, a digital file representing a work of literature may be downloaded from an affiliate vendor to the personal electronic device 148 of the participant, at a discount, when a milestone is reached. If the first participant expresses a preference for reaching a health goal, such as achieving a certain body-mass index (BMI) captured by the wearable device 146, an instruction may be generated to an affiliate insurance plan vendor indicating that the participant is eligible for an insurance plan discount when this milestone is reached.

At process 208, the first plurality of milestones is added by the progress tracking circuit 110 to the first goal. At process 210, the first plurality of electronic rewards is added by the progress tracking circuit 110 to the first goal. At process 212, the first plurality of rewards are customized to the first participant based at least in part on the first profile as described above.

At process 214, a first status item is generated by the progress tracking circuit 110. The first status item may be stored in the status tracker 118. A status item is a record of the participant's progress towards a goal. For example, in various embodiments, the first status item may be implemented as an electronic item storing the value of an account balance, as an electronic entity comprising all the relevant data points received from the wearable device 146, and/or as an electronic entity comprising all the health status indicators received from the wellness management system 144.

At process 216, the first goal is associated with the first status item. In some embodiments, the first goal is set such that it is consistent with a similar goal set by a participant's social networking connection. For example, if the participant's social networking connection has a yearly income of $100,000 and sets a goal of saving $10,000 per year and the participant has a yearly income of $50,000 and is looking to set a savings goal, the challenge discovery engine 108 may recommend setting a goal of saving $5,000 per year. The participants may be presented with goals expressed in terms of percentages to ensure their privacy rather than with numerical goals. As the participants' goals are equalized to saving 10% of income per year, the challenge is thereby adjusted to a viable level of appropriateness, and similar competition goals are thus defined. These factors individualize the challenge and create an emotional connection to achieving goals because the participants are realistically able to achieve the goals appropriate for their circumstances and are competing against similar participants. In various embodiments, the goal is adjusted such that the difficulty level of the challenge changes as the participant progresses and develops financial management skills.

At process 218, a first customized monitoring profile for the first participant is generated, by the integrated financial health monitoring circuit 112, based at least in part on the first profile, the first goal, and the first status item. A customized monitoring profile stores electronic definitions of parameters for observing and capturing information about events related to a participant's progress towards a financial health goal. The first customized monitoring profile includes, in some embodiments, a parameter delineating the frequency of polling auxiliary systems for electronic signals comprising information on, for example, a progress input. For example, a third party account system 134 may be polled every two hours to identify changes in the participant's account balance and/or a mobile device 158 may be polled every minute to identify changes in the participant's geographical location. Different participants may have different polling settings according to their customized monitoring profiles.

At process 220, the challenge is handicapped as described with reference to FIG. 3.

At process 222, a progress input is obtained. The term “progress input” refers to a single recently completed transaction or a potential transaction contemplated by the participant in real-time or near real-time. The participant may, for example, electronically scan an item he is interested in purchasing in order to supply this information. The progress input may, where so indicated by the context, further refer to an activity contemplated by the participant, such as a transfer of funds from one account to another. In some embodiments, the progress input is obtained in real time or near real-time based on the polling frequency determined at 218. In some embodiments, the financial health computing system 100 is configured obtain progress input by receiving push notifications from auxiliary systems.

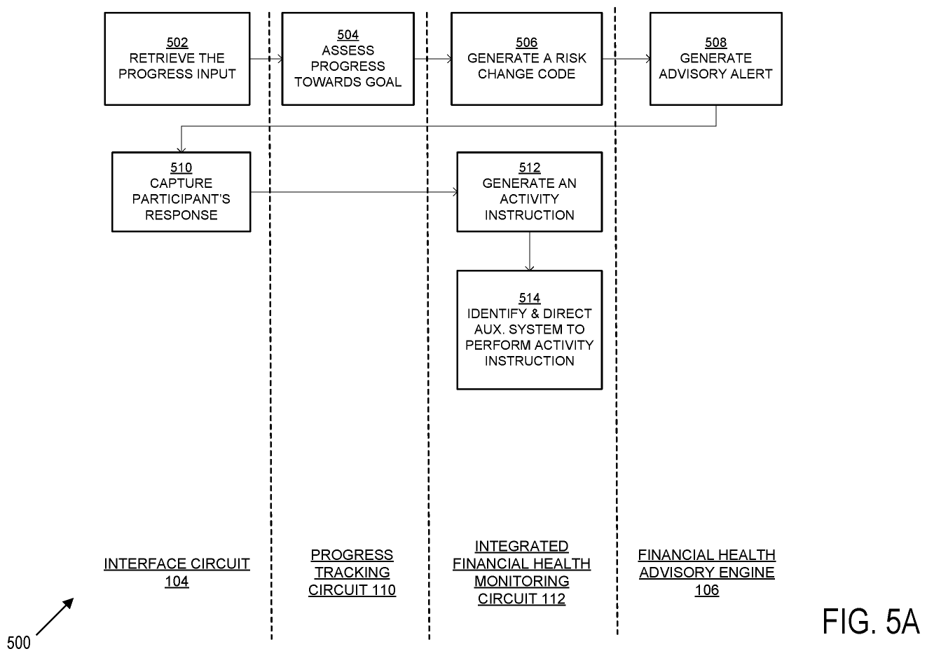

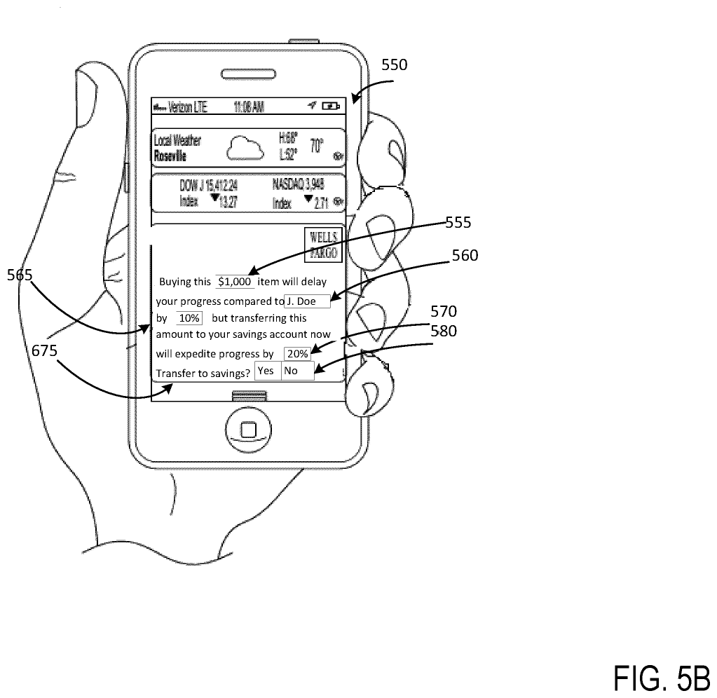

At process 224, the value of the first status item is updated in or near real-time as progress input is obtained. For example, if progress input represents a completed transaction, the value of the first status item may be adjusted to reflect a newly calculated account balance. If progress input represents a potential transaction, such as when a participant scans, via a bar code reader or near-field communications using mobile device 158, a price tag of an item contemplated for purchase, an advisory alert may be generated, as in 226, indicating that the first participant's goal may become less achievable in a given timeframe if the intended purchase is completed. Thus, the financial health computing system 100 correlates both the actual and anticipated spending and activity information to determine both actual and anticipated impact on the participant's goals. These processes and features are further described in reference to FIG. 5A and 5B, where, in a certain embodiment, a participant is provided with an advisory alert and with a user interface, delivered via the mobile device 158, for directing auxiliary systems to perform alternative, more beneficial, financial activities.

Referring now to FIG. 3, a flowchart is shown of a computer-implemented method 300 for handicapping a challenge in a financial health computing system 100, according to an example embodiment. Here, “handicapping” refers to identifying and equalizing the relevant variables, described further herein, so that the challenge is fair for all participants given each participant's unique characteristics and situation. Advantageously, making a goal reachable but appropriately challenging maximizes the participant's emotional investment.

Handicapping a challenge includes generating an electronic item that includes a handicapping factor. The term “handicapping factor” refers to a numerical value by which a participant's goals are adjusted so that the challenge is equalized or substantially equalized. Thus, the numerical value quantifies an advantage or a disadvantage imposed on a participant in a challenge. The handicapping factor is determined based on participant-specific information.

At process 302, participant-specific information is retrieved via the interface circuit 104 through the network 130. Participant-specific information is electronically stored in a suitable computing system used by the participant for personal and/or financial data management, such as a system or systems hosting the participant's financial accounts (e.g., financial institution computing system 156), electronic medical records, and/or entertainment media system(s).

According to some embodiments, participant-specific information relates to a participant's financial health. For example, participant-specific information retrieved from a retirement savings account system 132 may include access credentials and account balance. Participant-specific information retrieved from a third party account system 134 may include access credentials, account balance, and a record of value-exchange transactions (such as purchases) performed by the participant. According to various embodiments, participant-specific information may be gathered from any of the following: distributed ledger system 136 (e.g., access credentials, account balance), mortgage recordation system 140 (e.g., access credentials, account balance, participant's property value), and/or property recordation system 142 (e.g., access credentials, account balance, participant's property value, a record of value-exchange transactions such as transfers by deed).

Participant-specific information may be used to determine which rewards should be earned by the participant based on the participant's preferences. Thus, according to some embodiments, participant-specific information relates to the participant's well-being and/or lifestyle. In such embodiments, participant-specific information may be retrieved from any of the following systems: smartphone 138 (e.g., access credentials, geolocation), wellness management system 144 (e.g., access credentials, health data, health savings account balance, healthcare spending history), wearable device 146 (e.g., access credentials, vital information such as heart rate, number of steps taken, perspiration rate, geolocation), personal electronic device 148 (e.g., access credentials, digital file management functionality), and/or social networking system 150 (e.g., access credentials, friend list).

As an example of using participant-specific information to calculate the handicapping factor, the first participant may have expressed a preference for minimizing his or her average unpaid monthly balance on a retail credit account stored in the financial institution computing system 156, and this preference is therefore relevant to defining and handicapping the challenge for the participant. The interface circuit 104 may retrieve, through the network 130 and using the participant's access credentials for the financial institution computing system 156, the account balance, credit limit information, and any existing records of value-exchange transactions, such as purchases made by the participant. The challenge handicapping circuit 114 calculates the participant's credit utilization ratio as a percentage of account balance relative to the credit limit. This credit utilization ratio (for example, 50%) is expressed as a percentage rather than a dollar value and is used to handicap the challenge in relation to other participants who may have higher credit limits but also higher balances.

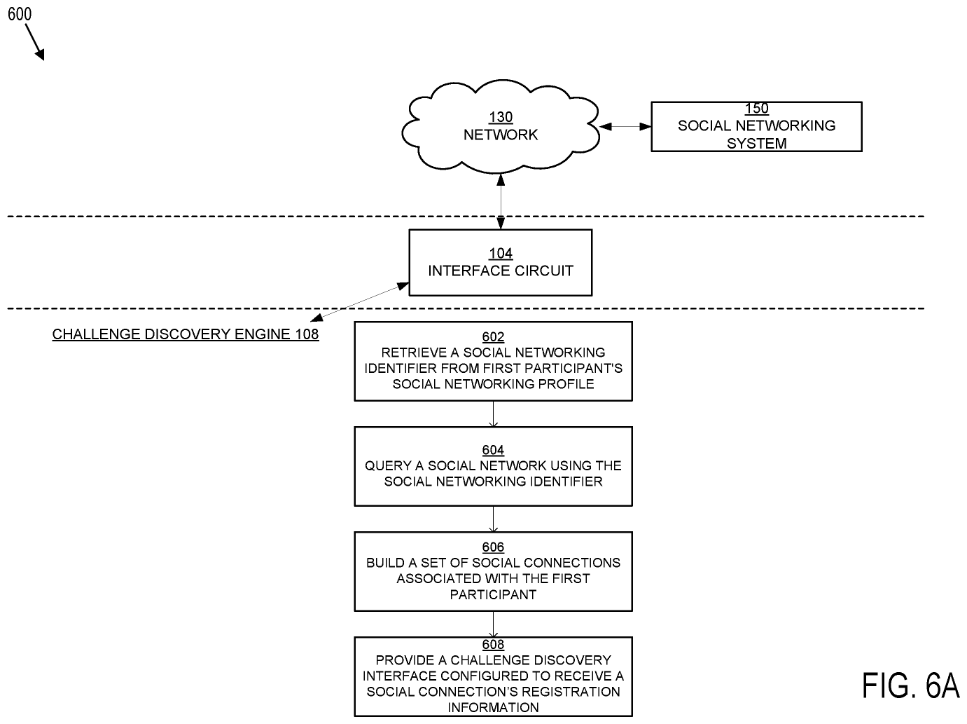

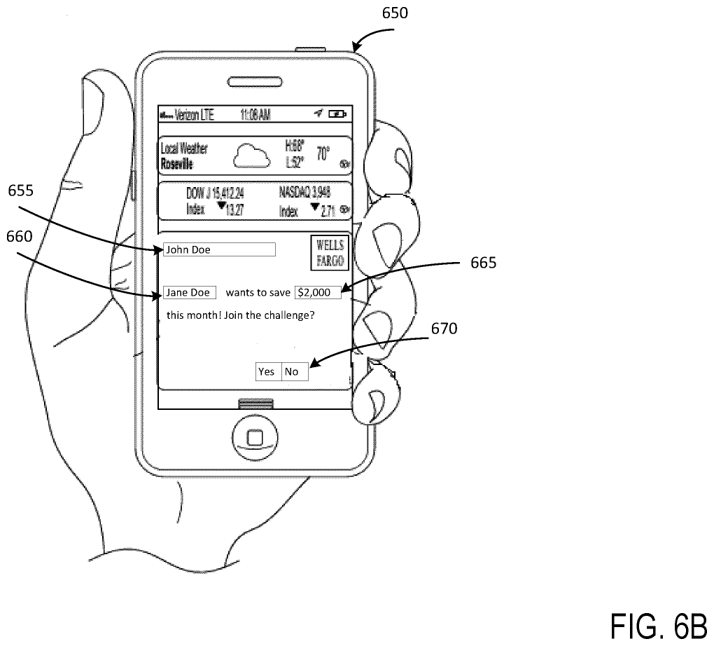

As discussed above, the participant's challenge is handicapped in relation to one or more other participants. This is accomplished by comparing the first participant to an example hypothetical system user represented by a virtual “competitor profile” with characteristics similar to those of the participant, by creating a profile representative of several users who are similar to the participant, by comparing the participant's current performance to that of the participant's social networking contact(s) invited to join the challenge as described in reference to FIG. 6A, or by comparing the participant's current performance to the participant's own historical performance.

At process 304, users (challenge participants) of the financial health computing system 100 who are similar to the first participant are identified. In some embodiments, a composite of the group of similar users is calculated, by the challenge handicapping circuit 114, such that each current user has a trait that is similar to that of the participant based on the assessment of information in the participant's profile from the assessment vault 116. In some embodiments, the profile information from the assessment vault 116 and milestone information from the milestone vault 122 is used to equalize the challenge such that, for example, the participant's relevant traits are compared to those of its competitors. For example, the assessment circuit 102 may identify system users whose credit scores are similar to that of the participant and who have similar incomes, similar levels of educational attainment, and/or similar occupations.

At process 306, a competitor profile is generated by the challenge handicapping circuit 114. The term “competitor profile” refers to a computerized collection of characteristics of a simulated (theoretical) participant against which the user (first participant) may compete. The term “competitor characteristic,” as used herein, denotes a relevant trait in the competitor profile, such as, for example, annual income, number of dependents, and/or level of education. These relevant traits are used to equalize the challenge.

At process 308, a second goal is generated for the second participant as described in reference to FIG. 2.

At process 310, a handicapping factor is calculated based at least on comparing the first goal associated with the first participant to the second goal associated with the second participant. One example of a handicapping factor is a savings goal expressed as a percentage of income per month so that users with different incomes may compete against one another in a challenge. Another example of a handicapping factor is a cost-of-living index in the locality where a participant lives, as illustrated below. Yet another example of a handicapping factor is the number of the participant's dependents. Further examples of handicapping factors are: a participant's availability to work a certain number of hours per week based, for example, on the participant's commitments or health status; the participant's level of educational attainment; the participant's outstanding financial obligations; and/or the participant's net cash flow per month.

The handicapping factor is an outcome of an equalization calculation. One example of an equalization calculation uses a participant's debt as a percentage of income. The debt and income values may be retrieved, for example, from the third party account system 134. Another example equalization calculation uses a participant's property value, which can be retrieved, for example, from the property recordation system 142 and compared to an average of property values in the participant's locality. Another example of equalization is calculating the participant's net savings per month, which can be retrieved, for example, from a retirement savings account system 132, as a percentage of the participant's income. Yet another example is an adjustment based on the cost of living.

As an example of handicapping a challenge using an equalization calculation, a first participant may reside in a state and county where the median house value is $250,000 and a second participant may reside in a different state and county where the median house value is $400,000. Both participants may have annual incomes of $100,000 and both may desire to pay off their mortgages as soon as possible. In this version of a challenge, it may be determined that while the first participant could accomplish the goal in 5 years, it would take the second participant 10 years to accomplish the same goal. Instead of using straight numbers or, for example, loan-to-value (LTV) percentages, the challenge may be handicapped such that the participants are enabled to compete against one another on the percentage of income they allocate toward extra payments on their mortgages, which equalizes the challenge.

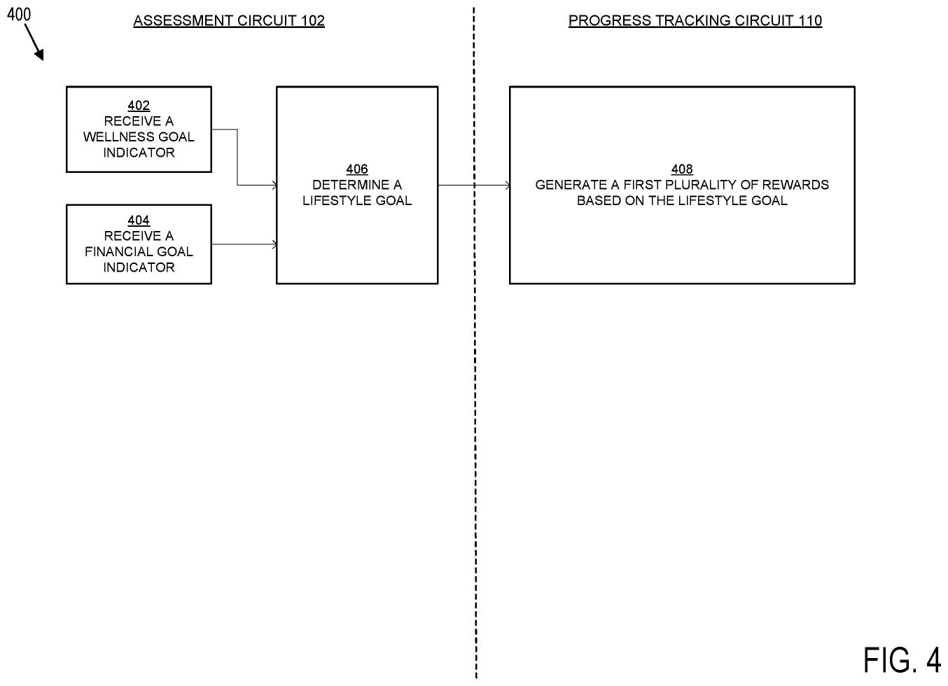

Referring now to FIG. 4, a flowchart is shown of a computer-implemented method 400 for generating a profile in a financial health computing system 100, according to an example embodiment. At process 402, a wellness goal indicator is received, representing a participant's wellness goal. At process 404, a financial goal indicator is received, representing a participant's financial goal. At process 406, a lifestyle goal indicator is received and set. The lifestyle goal indicator is set based at least on the wellness goal, the financial goal, or both. At process 408, a first plurality of rewards is generated based at least on the lifestyle goal.

Referring now to FIG. 5A, a flowchart is shown of a computer-implemented method 500 for generating advisory alerts in a financial health computing system 100, according to an example embodiment. A further illustration, depicting an example embodiment, is provided in FIG. 5B.

At process 502, an interface circuit (e.g., the interface circuit 104) retrieves a user progress input. As discussed in reference to FIG. 2 and according to various embodiments, the progress input may be a scanned price of a contemplated purchase, a health indicator, a geolocation data item positioning the participant in proximity to, for example, an affiliate retailer, and/or another suitable electronic item. According to various embodiments, the user progress input may be retrieved from any of the following devices associated with a challenge participant: mobile device 158, wearable device 146, personal electronic device 148, and/or the social networking system 150. For example, the interface circuit 104 may retrieve a scanned price of a contemplated purchase item from the participant's mobile device 158 and geolocation data from the participant's wearable device 146. As described below, these items may be used by the financial health advisory engine 106 to identify an affiliate retailer that offers a lower price or no-interest payment terms on the item contemplated for purchase.

At process 504, the progress tracking circuit provides instructions to one or both of the integrated financial health monitoring circuit 112 and financial health advisory engine 106 to assess the participant's progress towards a goal based on the progress input and to generate an advisory alert based on the assessment. According to various embodiments, the financial health monitoring circuit may retrieve the participant's current deposit account balance from, for example, the third party account system 134 and compare this value to the dollar value of the anticipated transaction. The advisory alert may include functionality for accepting and executing a user instruction in an auxiliary system, as described in reference to processes 512-514.

At process 506, the integrated financial health monitoring circuit 112 generates a risk change code. As described in reference to FIG. 5B, the risk change code approximates the likelihood of goal achievement based on an assessment of the participant's anticipated action (such as a purchase) in relation to a relevant environmental variable or circumstance.

At process 508, an advisory alert is generated to be rendered to the challenge participant. The advisory alert reflects the risk change code. For example, an advisory alert generated by the financial health advisory engine 106 may warn a participant that the participant's competitor is 10% closer to achieving his goal than the participant is or that based on the participant's contemplated purchase information captured at 502, the probability is 90% that the participant will achieve his or her goal when planned.

At process 510, a response is captured from the participant. For example, the participant may instruct the financial health computing system 100 to move the amount of the contemplated purchase to a savings account instead of completing the purchase. In some embodiments, the response is based on a recommendation provided by the financial health advisory engine 106. For example, the participant may choose to apply for credit at the affiliate retailer, identified by the financial health computing system 100 based on the geolocation information obtained at 502, if the affiliate retailer offers better savings and/or purchase terms.

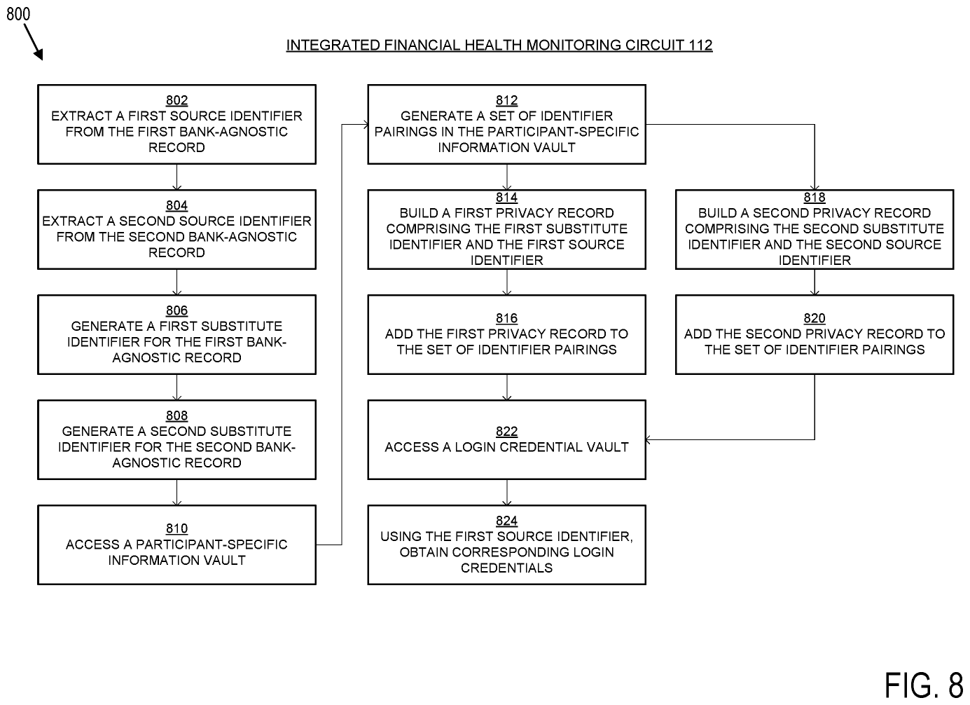

At process 512, a user activity instruction is generated by the integrated financial health monitoring circuit 112 and, at process 514, an auxiliary system is identified and directed through, for example, executable code, to carry out appropriate actions based on the participant's response captured at 510. The auxiliary system is accessed to execute the instruction as described in reference to processes 822 and 824 of FIG. 8.

Referring now to FIG. 5B, a diagram is shown of an interface 550 for managing activity instructions for auxiliary systems based on the advisory alert generated by a financial health computing system 100.

In an example scenario according to the embodiment of FIG. 5B, the interface 550 is presented to a participant (user 190 of FIG. 1A) via the mobile device 158. According to various embodiments, the interface 500 may be implemented as an interactive display, a touch-responsive surface, and/or a motion-responsive surface. The participant may scan or otherwise enter the price 555 of an item contemplated for purchase such that the price 555 of the item is captured by the progress tracking circuit 110. The integrated financial health monitoring circuit 112 may estimate the impact of a contemplated $1,000 debit card purchase from an account associated with the first third party account system 134 on the participant's goal to save $5,000 per year. In this scenario, the participant may compete with his or her social networking connection 560. The integrated financial health monitoring circuit 112 may estimate that buying the item would delay the participant's progress by a calculated amount, duration of time, and/or a percentage thereof based on the first risk change score 565. The integrated financial health monitoring circuit 112 may estimate that avoiding the contemplated purchase and transferring the amount 555 of the contemplated purchase to the participant's savings account residing on a second third party account system 134 would accelerate the participant's progress by a calculated amount based on a second risk change score 570, which is calculated in a manner similar to that of the first risk change score 565. A user activity instruction 575 to complete the funds transfer may be generated and rendered to the participant by the financial health advisory engine 106, and a responsive activity instruction from the participant may be captured by the controls 580. The activity instruction is evaluated and used at process 514 of FIG. 5A to direct the corresponding activity (in the example above, a transfer of funds to the savings account) in the second third party account system 134.

Referring now to FIG. 6A, a flowchart is shown of a computer-implemented method 600 for managing challenge discovery via a social network associated with the user of a financial health computing system 100, according to an example embodiment.

At process 602, a social networking identifier is retrieved, by the interface circuit 104 via the network 130, from a social networking profile residing on the social networking system 150. The social networking profile is associated with the first participant. In some embodiments, the social network identifier is retrieved from the login credential vault 154 using access information that is managed as described, for example, with reference to FIG. 8 herein.

At process 604, the first participant's social network is queried using the social networking identifier. A list of the first participant's social networking connections, such as a friend list, is obtained.

At process 606, a set of social connections that are associated with the first participant is generated and, at process 608, an interface for challenge discovery (one embodiment thereof provided in FIG. 6B and described with respect thereto) is provided to each contact in the set of social connections associated with the first participant.

Thus, a first participant's social connection may register in the financial health computing system 100. The social connection is considered a second participant with respect to the first participant. A second goal may be generated, in some embodiments, for the second participant as described with respect to FIG. 2, and the first participant's challenge may be handicapped with respect to the second participant's activity as described with reference to FIG. 3. Thus, individuals connected via the social networking system 150 may compete against one another in the financial health computing system 100 with respect to financial health goals, which may impart a further emotional connection to the challenge.

Referring now to FIG. 6B, a diagram is shown of an interface for challenge discovery 650 in a financial health computing system.

The interface for challenge discovery 650 is presented to a participant's 660 social network connection 655 via a mobile device 158, such as a smartphone 138 or a personal electronic device 148. According to various embodiments, the interface 650 may be implemented as an interactive display, a touch-responsive surface, and/or a motion-responsive surface. The social network connection 655 is alerted, through a message generated by the challenge discovery engine 108 and rendered by the financial health advisory engine 106, of the participant's first goal 665 defined at process 204. A message is generated and rendered to the social network connection 665 asking whether the social network connection 665 wants to join the challenge, and the social network connection's response is captured at 670. The response is used to create a profile for the second participant in the financial health computing system 100.

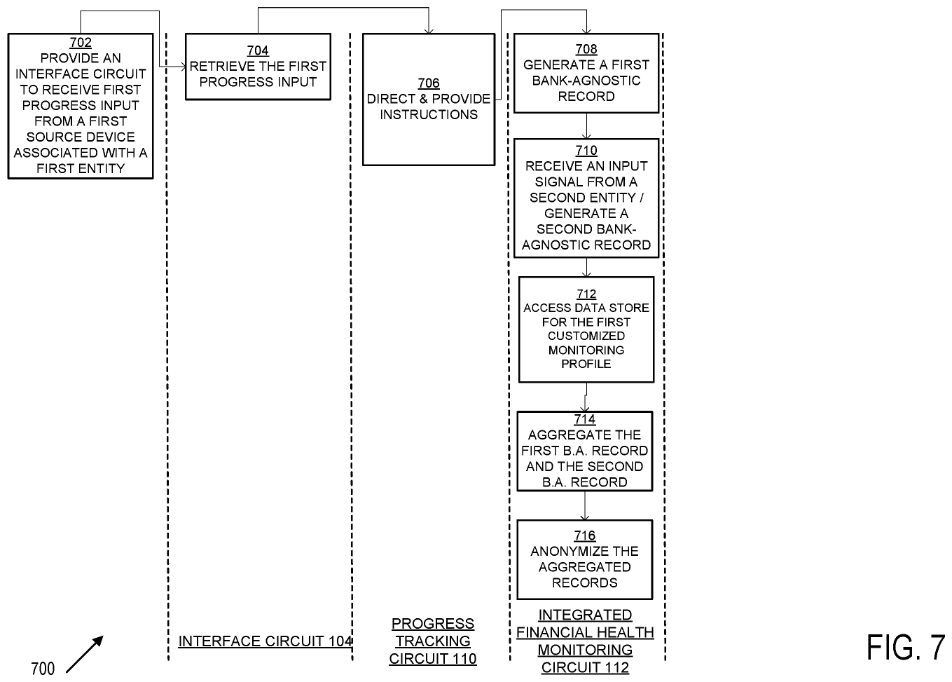

Referring now to FIG. 7, a flowchart is shown of a computer-implemented method 700 for generating a bank-agnostic record that associates the financial health computing system 100 of FIG. 1A with one or more auxiliary system(s).

Herein, bank-agnostic refers to an arrangement enhancing system performance and/or security of data where the data store for the customized monitoring profile defined at 218 is decoupled from the entity (e.g., the data store of an auxiliary system) associated with providing the progress input for the participant as described in FIGS. 2 and 5A. System performance, in this context, refers to optimized network communications and/or optimized data storage and retrieval, as described below. Decoupling the entities means that there is no apparent, unsecured link between the source system and the financial health computing system 100. In some embodiments, decoupling the entities creates a shadow copy of the source data, the shadow copy being stored in the financial health computing system 100 to facilitate data analysis and aggregation and to preserve historical records generated and/or received by the financial health computing system 100.

At process 702, an interface is provided to receive the first progress input from the first participant. The first progress input may originate from a first source entity, such as the first auxiliary system, which may be, for example, a financial institution computing system 156. At process 704, the first progress input is retrieved. In some embodiments, the first progress input may include the participant's current account balance, a data point received from the wearable device 146, or a health metric received from the wellness management system 144. In addition, the first progress input includes the participant's login credentials and/or a key needed for decryption of data on the auxiliary system.

At process 706, the progress tracking circuit directs and provides instructions to execute the processes described below to the integrated financial health monitoring circuit 112.

The integrated financial health monitoring circuit 112, at process 708, generates a first bank-agnostic record based at least on the participant's login credentials for the auxiliary system and/or on a key needed to decrypt the data from the auxiliary system that is associated with the first progress input.

To illustrate processes 702-708, a first progress input may be received from a first participant's third party account system 134, which hosts the first participant's savings account. The first progress input includes the first participant's login identifier and password for accessing the participant's savings account. A first bank-agnostic record is generated in the bank account aggregator 124 and includes this information along with the first participant's unique identifier for the financial health computing system 100.

At process 710, an input signal is received from a second entity, and a second bank-agnostic record is generated. In some embodiments, the second entity is different from the entity associated with providing the first progress input. In some embodiments, the input signal includes an account balance, a data point received from the wearable device 146, or a health metric received from the wellness management system 144. In addition, the input signal includes a participant's login credentials for the auxiliary system and/or a key needed to decrypt the data of the auxiliary system. In some embodiments, the second bank-agnostic record is generated based at least on the participant-specific information described in reference to FIG. 3. Thus, the second bank-agnostic record is generated based at least on the login credentials for the auxiliary system and/or based on a key needed to decrypt the data of the auxiliary system associated with the input signal.

To illustrate the process 710, an input signal may be received from a second participant's third party account system 134, which hosts the second participant's savings account. The input signal includes the second participant's login identifier and password for accessing the savings account. A second bank-agnostic record is generated in the bank account aggregator 124 and includes this information along with the second participant's unique identifier from the financial health computing system 100.

At process 712, a data store for the first customized monitoring profile generated at 218, such as the monitoring profile vault 152, is accessed in order to, at process 714, aggregate the first bank-agnostic record and the second bank-agnostic record in the bank account aggregator 124.

In some embodiments, the bank account aggregator 124 includes the monitoring profile vault 152 such that records stored therein are grouped by participant. In certain embodiments, therefore, the first bank-agnostic record generated at 708 and the second bank-agnostic record generated at 710 may belong to the same participant who may, for example, have different accounts at two or more financial institutions. Such an implementation enables the association of polling frequency data from the monitoring profile vault 152, which includes instructions for directing the financial health computing system 100 to monitor signals from auxiliary (source) systems at predefined periodic intervals, with the first bank-agnostic record and/or with the second bank agnostic record that include identifiers pointing to the participant's login information. For example, the first bank-agnostic record for the first participant may be refreshed every minute to reflect newly gathered information on changes in the first participant's savings account balance, and the participant's second bank-agnostic record may likewise be refreshed every minute to retrieve newly gathered information on changes in the second participant's second savings account balance associated with a different account.

Further with respect to multiple bank-agnostic records generated for the same participant, in some embodiments comprising handicapping challenges as described in reference to FIG. 3, records from different third party accounts 134, distributed ledger systems 136, and retirement savings accounts 132, associated with the first participant, are grouped together and are made available to the financial health advisory engine 106, progress tracking circuit 110, and integrated financial health monitoring circuit 112 in a secured fashion. The records are decoupled from their source data stores to reduce the number of data communications messages sent across the network and to make the data readily available for analytical modeling, such as that performed by the financial health advisory engine 106 and the integrated financial health monitoring circuit 112. As an example, the first bank-agnostic record for the first participant may be accessed once a day to retrieve new information about changes in the first participant's savings account balance. Each daily change may be recorded in the bank account aggregator 124. In a challenge where the participant competes against him- or herself, the history of changes may be used to calculate or update the participant's goal and to adjust the handicapping factor based on the participant's own history of progress. Thus, the participant's interest in the challenge is maintained over time as the goal is set to a progressively higher value, making goal achievement personally rewarding.

At process 716, the first and second bank-agnostic records are anonymized as described in reference to FIG. 8.

Referring now to FIG. 8, a flowchart is shown of a computer-implemented method 800 for anonymizing the bank-agnostic record that associates the financial health computing system 100 of FIG. 1A with one or more auxiliary system(s), according to an example embodiment. In this context, anonymizing refers to generating a set of substitute identifier pairings to ensure the security of items associated with the bank-agnostic records and maintaining, in a secured vault, such as the login credential vault 154, a de-identifying data set linking substitute identifiers with original identifiers from their respective source systems.

At process 802, a first source identifier is extracted from the first bank-agnostic record. At process 804, a second source identifier is extracted from the second bank-agnostic record. Source identifiers are electronic entity login identifiers received from auxiliary systems as described with reference to FIG. 3 (referring particularly to participant-specific information) and FIG. 7.

At process 806, a first substitute identifier is generated for the first bank-agnostic record and, at process 808, a second substitute identifier is generated for the second bank-agnostic record. In some embodiments, substitute identifiers are generated as random numbers. In other embodiments, substitute identifiers are generated as Global Unique Identifiers (GUID). In yet other embodiments, substitute identifiers are generated as 128-bit Universally Unique Identifiers (UUID). In yet other embodiments, substitute identifiers are generated as any suitable variants pursuant to RFC 4122 or another applicable systems management standard.

At process 810, a participant-specific information vault (e.g., participant-specific information vault 126) is accessed. At process 812, a set of identifier pairings is generated in the participant-specific information vault 126. The set of identifier pairings includes the first source identifier and the first substitute identifier. In some embodiments, the first source identifier is added to the relevant record in the bank account aggregator 124 and the login information previously stored in the bank account aggregator 124 is erased and moved to the login credential vault 154 such that the aggregated personal and financial information pertaining to a participant is de-identified.

At process 814, a first privacy record is built in the participant-specific information vault, the first privacy record containing the first substitute identifier associated with the first source identifier. A privacy record is an electronic record linking substitute identifiers for a participant's respective auxiliary systems with those systems' actual participant identifiers. At process 816, the first set of identifier pairings is added to the first privacy record.

In some embodiments, at process 818, a second privacy record is built comprising the second substitute identifier and the second source identifier. The second privacy record is added to the set of identifier pairings at process 820. Thus, the set of identifier pairings contains all identifier pairings from multiple and/or different auxiliary systems that are associated with the first participant. For example, the first participant may have two different third party accounts on two different auxiliary systems, such as third party account systems 134, or the first participant may have accounts on a retirement savings account system 132, a third party account system 134, a distributed ledger system 136, and a social networking system account 150. In this implementation, if the participant's level of openness to sharing personal financial information so allows, login information for multiple systems is centralized so that the management of financial health goals is simplified.

At process 822, the login credential vault 154 is accessed. The login credential vault 154 stores a participant's login credentials for auxiliary systems, which correspond to the first source identifier.

At process 824, using the first source identifier, the corresponding login credentials for the first participant are obtained. These login credentials are used, for example, at process 514, where an auxiliary system is identified and directed to execute actions corresponding to an activity instruction generated at process 512 based on input received from the first participant. In some implementations, the login credential vault 154 is the participant-specific information vault 126.

The arrangements described herein have been described with reference to drawings. The drawings illustrate certain details of specific arrangements that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective circuit may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the circuit may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

The circuit may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a circuit as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, video and audio recording devices, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions and arrangement of the embodiments without departing from the scope of the present disclosure as expressed in the appended claims.

1. A computer-implemented method for monitoring progress towards financial goals using a financial health computing system comprising an assessment circuit, a progress tracking circuit, an integrated financial health monitoring circuit, and a financial health advisory circuit, the method comprising:
generating, by the assessment circuit, a first profile for a first participant, the generation based on data provided by the first participant, geotracking data of the first participant, and data extracted from a social networking account associated with the first participant, wherein the geotracking data includes an aggregation of past movements of the first participant during a predetermined time frame;
generating, by the progress tracking circuit, a first goal for the first participant, the first goal comprising a first plurality of milestones and a first plurality of rewards, wherein the first goal and the first plurality of rewards are customized to the first participant based at least in part on the first profile;
assessing, by the progress tracking circuit, the first participant's actual and anticipated progress towards the first goal using synchronized data updates from a plurality of auxiliary computing systems according to a unified polling frequency schedule, wherein the synchronized data updates comprise periodically updating, by the financial health computing system, a shadow copy of auxiliary computing system data accessible to the financial health computing system and decoupled from a respective auxiliary computing system; and
generating, by a financial health advisory circuit, an advisory alert for the first participant, the advisory alert comprising a recommended financial health activity and an interface for accepting a user input for directing an auxiliary system to perform the recommended financial health activity.

2. The method of claim 1, further comprising generating a handicapping factor by performing the processes of:
generating, by the integrated financial health monitoring circuit, a second goal for a second participant; and
calculating, by a challenge handicapping circuit of the financial health computing system, the handicapping factor based at least on comparing the first goal and the second goal.

3. The method of claim 2, wherein the second participant has a competitor profile generated by the challenge handicapping circuit based at least in part on a competitor characteristic.

4. The method of claim 2, wherein the second participant is a composite of a group calculated by the challenge handicapping circuit based at least in part on a trait relevant to the first participant.

5. The method of claim 4, wherein the composite of a group is calculated by the challenge handicapping circuit from a set of current users of the financial health computing system such that each in the set of current users correlates to a value in the first profile, the value in the first profile determined by the assessment circuit of the financial health computing system.

6. The method of claim 4, wherein the composite of a group is calculated from a set of historical variables retrieved by a status tracker circuit of the financial health computing system such that each in the set of historical variables correlates to a trait relevant to the first participant as determined by the assessment circuit of the financial health computing system.

7. The method of claim 6, wherein the set of historical variables is associated, by the assessment circuit, with the first participant such that each in the set of historical variables represent the first participant's prior activity.

8. The method of claim 2, wherein the handicapping factor is calculated, by the challenge handicapping circuit, based at least on a creditworthiness rating of the first participant.

9. The method of claim 2, wherein the handicapping factor is calculated, by the challenge handicapping circuit, based at least on participant-specific information associated with the first participant.

10. The method of claim 9, wherein the participant-specific information is an account balance representing fiat currency.

11. The method of claim 9, wherein the participant-specific information is a digital ledger balance representing digital currency.

12. The method of claim 9, wherein the participant-specific information is an asset value.

13. The method of claim 9, wherein the participant-specific information is a value-exchange transaction.

14. The method of claim 2, wherein generating, by the assessment circuit, the first profile for the first participant further comprises:
determining, by the assessment circuit, a lifestyle goal indicator of the first participant;
generating, by the progress tracking circuit, the first plurality of rewards based at least on the lifestyle goal indicator.

15. The method of claim 14, wherein the lifestyle goal indicator further comprises a wellness goal of the first participant.

16. The method of claim 14, wherein the lifestyle goal indicator further comprises a financial goal of the first participant.

17. The method of claim 14, wherein at least one in the first plurality of rewards is a negative reward.

18. The method of claim 2, further comprising:
providing, by the financial health computing system, an interface circuit to receive a progress input;
assessing, by the progress tracking circuit, the first participant's progress towards the goal;
generating, by the integrated financial health monitoring circuit, a risk change code for the first participant, the risk change code based at least on comparing the first goal to the progress input;
directing, by the progress tracking circuit, the financial health advisory circuit to generate the advisory alert based at least in part on the risk change code;
providing, by the financial health advisory circuit, the advisory alert to the first participant;
capturing, by the interface circuit, an activity instruction responsive to the advisory alert from the first participant;
identifying, by the integrated financial health monitoring circuit, an auxiliary system and directing, by the integrated financial health monitoring circuit, the auxiliary system to perform the activity instruction.

19. The method of claim 2, further comprising:
providing, by the financial health computing system, the interface circuit to receive the progress input from a first source device;
retrieving, by the interface circuit, the first progress input; and
directing, by the progress tracking circuit, the integrated financial health monitoring circuit to generate a first bank-agnostic record.

20. The method of claim 19, further comprising:
generating, by the integrated financial health monitoring circuit, a second bank-agnostic record based in part on an input signal from a second entity different from an entity associated with the first source device providing the progress input;
aggregating, by the integrated financial health monitoring circuit in a bank account aggregator, the second bank-agnostic record and the first bank-agnostic record; and
anonymizing, by the integrated financial health monitoring circuit, the first bank-agnostic record and the second bank-agnostic record so as to decouple the first bank-agnostic record from the first source device associated with providing the progress input and to decouple the second bank-agnostic record from the second entity.

21. The method of claim 20, wherein anonymizing, by the integrated financial health monitoring circuit, the first bank-agnostic record and the second bank-agnostic record further comprises:
extracting, by the integrated financial health monitoring circuit, a first source identifier from the first bank-agnostic record and a second source identifier from the second bank-agnostic record;
generating, by the integrated financial health monitoring circuit, a first substitute identifier for the first bank-agnostic record and a second substitute identifier for the second bank-agnostic record;
generating, by the integrated financial health monitoring circuit, a set of identifier pairings in a participant-specific information vault;
adding, by the integrated financial health monitoring circuit, a first privacy record to the set of identifier pairings in a participant-specific information vault, the first privacy record comprising the first substitute identifier and the first source identifier;
augmenting, by the integrated financial health monitoring circuit, the first privacy record by accessing a login credential vault of the augmented financial health computing system to obtain the first participant's login credentials corresponding to the first source identifier; and
adding the second privacy record to the set of identifier pairings, the second privacy record comprising the second substitute identifier and the second source identifier.

22. The method of claim 3, further comprising:
retrieving, by a challenge discovery module of the financial health computing system, a social networking identifier from the social networking profile associated with the first participant;
querying, by the challenge discovery module, a social network based at least in part on the social networking identifier;
building, by the challenge discovery module, a set of social connections associated with the first participant; and
providing, by the challenge discovery module of the financial health computing system, a challenge discovery interface to each in the set of social connections, the challenge discovery interface configured to receive registration information associated with one of the set of social connections.

23. The method of claim 1, further comprising determining, by the progress tracking circuit, the first goal for the first participant based at least in part on the first profile.

24. A financial health computing system comprising an assessment circuit, a progress tracking circuit, an integrated financial health monitoring circuit, a financial health advisory circuit, and at least one processor and memory, the memory having instructions stored therein that are executed by the at least one processor and cause the at least one processor to:
generate, by the assessment circuit, a first profile for a first participant, the generation based on data provided by the first participant, geotracking data of the first participant, and data extracted from a social networking account associated with the first participant, wherein the geotracking data includes an aggregation of past movements of the first participant during a predetermined time frame;
generate, by the progress tracking circuit, a first goal for the first participant, the first goal comprising a first plurality of milestones, and a first plurality of rewards, wherein the first goal and the first plurality of rewards are customized to the first participant based at least in part on the first profile;
assess, by the progress tracking circuit, the first participant's actual and anticipated progress towards the first goal comprising operations to synchronize data updates from a plurality of auxiliary computing systems according to a unified polling frequency schedule, wherein synchronized data updates comprise operations to periodically update, by the financial health computing system, a shadow copy of auxiliary computing system data accessible to the financial health computing system and decoupled from a respective auxiliary computing system; and
generate, by a financial health advisory circuit, an advisory alert for the first participant, the advisory alert comprising a recommended financial health activity and an interface for accepting a user input for directing an auxiliary system to perform the recommended financial health activity.

25. The system of claim 24, wherein a handicapping factor is generated such that the memory further comprises instructions stored therein that are executed by the at least one processor and cause the at least one processor to:
generate, by the integrated financial health monitoring circuit, a second goal for a second participant;
calculate, by a challenge handicapping circuit of the financial health computing system, the handicapping factor based at least in part on comparing the first goal and the second goal.

26. The system of claim 24, wherein the second participant has a competitor profile generated by the challenge handicapping circuit based at least in part on a competitor characteristic.

27. The system of claim 24, wherein the second participant is a composite of a group calculated by the challenge handicapping circuit based at least in part on a trait relevant to the first participant.

28. The system of claim 25, wherein the handicapping factor is calculated, by the challenge handicapping circuit, based at least in part on a creditworthiness rating of the first participant.

29. The system of claim 25, wherein the handicapping factor is calculated, by the challenge handicapping circuit, based at least in part on a participant-specific information associated with the first participant.

30. The system of claim 29, wherein the participant-specific information is an account balance representing fiat currency.

31. The system of claim 29, wherein the participant-specific information is a digital ledger balance representing digital currency.

32. The system of claim 29, wherein the participant-specific information is an asset value.

33. The system of claim 29, wherein the participant-specific information is a value-exchange transaction.

34. The method of claim 1, further comprising:
generating a first bank-agnostic record regarding a first set of transaction information pertaining to a first account associated with the first participant and a second bank-agnostic record regarding a second set of transaction information pertaining to a second account associated with the first participant;
storing the first bank-agnostic record and the second bank-agnostic record relationally to anonymized information regarding an identity of the first participant;
generating the unified polling frequency schedule for the first bank-agnostic record and the second bank-agnostic record and storing the unified polling frequency schedule relationally to the anonymized information regarding the identity of the first participant; and
determining the progress towards the first goal, comprising periodically updating the first bank-agnostic record and the second bank-agnostic record according to the unified polling frequency schedule.
